(19) United States
(12) Patent Application Publication
(10) Pub. No.: US 2025/0070920 A1
(43) Pub. Date: Feb. 27, 2025

(54) SYSTEM

(71) Applicant: TOYOTA JIDOSHA KABUSHIKI KAISHA, Toyota-shi (JP)

(72) Inventors: Shigeki MATSUMOTO, Nagoya-shi (JP); Naoya Oka, Nagoya-shi (JP); Hidetaka Eguchi, Nagoya-shi (JP); Shigeru Ichikawa, Nagoya-shi (JP); Takeshi Yamada, Nagoya-shi (JP); Masayo Nagai, Nagoya-shi (JP); Ryosuke Yamamoto, Nagoya-shi (JP)

(73) Assignee: TOYOTA JIDOSHA KABUSHIKI KAISHA, Toyota-shi (JP)

(21) Appl. No.: 18/750,290

(22) Filed: Jun. 21, 2024

(30) Foreign Application Priority Data
Aug. 23, 2023 (JP) 2023-135485

(51) Int. Cl. H04L 1/18; H04L 67/12; H04L 67/568

(52) U.S. Cl. CPC H04L 1/18; H04L 67/12; H04L 67/568

(57) ABSTRACT

In a system including a first device and a second device, the first device transmits data to the second device and stores the data in a first database. When retransmission of the data is requested from the second device, the first device transmits the data stored in the first database to the second device.

### CROSS-REFERENCE TO RELATED APPLICATION

This application claims priority to Japanese Patent Application No. 2023-135485 filed on Aug. 23, 2023, incorporated herein by reference in its entirety.

### BACKGROUND

### 1. Technical Field

The present disclosure relates to systems.

### 2. Description of Related Art

Japanese Unexamined Patent Application Publication No. 2020-072278 (JP 2020-072278 A) discloses a vehicle communication system. The vehicle communication system disclosed in JP 2020-072278 A includes vehicle terminals and a mobile edge computing (MEC) server. The vehicle terminals transmit identification information that allows unique identification of the vehicle terminals and request information. The MEC server receives, from the vehicle terminal located in the range where the MEC server can provide services, identification information and service content requested by the vehicle terminal. The MEC server stores a correspondence table between the received identification information and service content, and set a service to be provided to the vehicle terminal corresponding to the identification information in the correspondence table. The MEC server then provides the service to the vehicle terminal.

### SUMMARY

It is an object of the present disclosure to provide a technique that allows acquisition and use of data at a necessary timing.

A system according to the present disclosure is

a system including a first device and a second device.
The first device is configured to
transmit data to the second device and store the data in a first database, and when retransmission of the data is requested from the second device, transmit the data stored in the first database to the second device.

The present disclosure allows acquisition and use of data at a necessary timing.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of an information providing system;

FIG. 2 is a block diagram schematically illustrating an example of an in-vehicle device and a server;

FIG. 3 is a diagram illustrating an example of a table configuration of vehicle information held in a vehicle information database;

FIG. 4 is a flowchart of a first process that is executed by a control unit of the in-vehicle device;

FIG. 5 is a flowchart of a second process that is executed by the control unit of the in-vehicle device; and

FIG. 6 is a flowchart of a third process that is executed by a control unit of the server.

### DETAILED DESCRIPTION OF EMBODIMENTS

A system according to the present disclosure is a system including a first device and a second device. Here, the first device transmits data (hereinafter, may be simply referred to as “data”) to the second device. At this time, when the second device attempts to use the data received from the first device, the second device may not hold the data. The system according to the present disclosure solves such problems.

In the system according to the present disclosure, the first device transmits data to the second device and stores the data in the first database. When the retransmission of the data is requested from the second device, the first device transmits the data stored in the first database to the second device. In this way, the system according to the present disclosure allows the second device to receive data again. As a result, data can be acquired and used at necessary timings.

Hereinafter, embodiments of the present disclosure will be described with reference to the drawings. A hardware configuration, a module configuration, a functional configuration, etc., described in each embodiment are not intended to limit the technical scope of the disclosure to them only unless otherwise stated.

### Embodiment

### System Overview

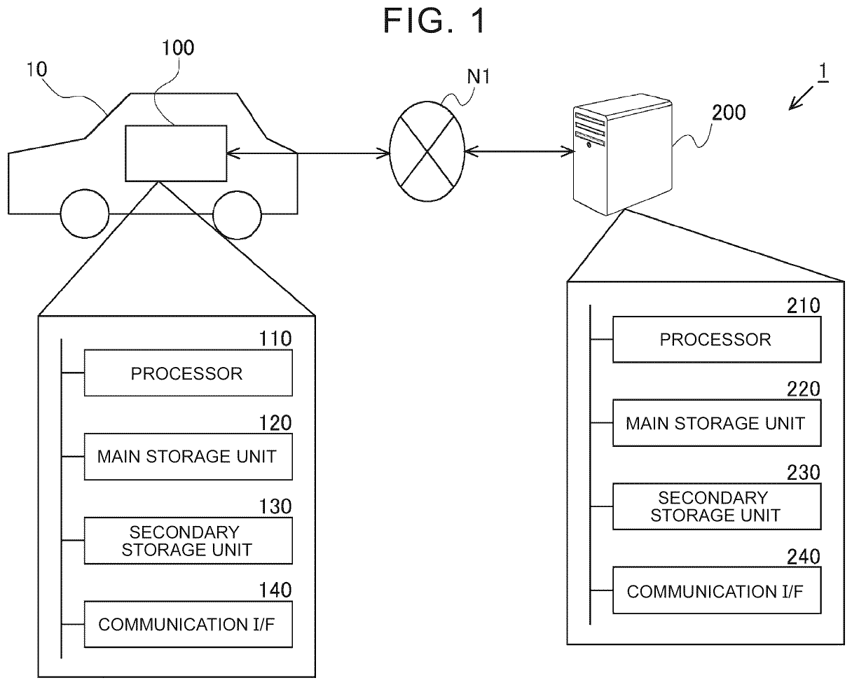

The information providing system 1 according to the present embodiment will be described with reference to FIG. 1. FIG. 1 is a diagram illustrating a schematic configuration of an information providing system 1. The information providing system 1 includes an in-vehicle device 100 and a server 200. In the information providing system 1, the in-vehicle device 100 and the server 200 are connected to each other via a network N1. The network N1 may employ, for example, a Wide Area Network (WAN) which is a global public communication network such as the Internet, or a telephone communication network such as a mobile telephone.

### In-Vehicle Device

The in-vehicle device 100 is a device mounted on the vehicle 10. The in-vehicle device 100 acquires information on the traveling state of the vehicle 10 (hereinafter, sometimes referred to as “vehicle information”) from an electronic control unit (ECU) or the like of the vehicle 10. In the present embodiment, the vehicle information is information including data indicating the location of the vehicle 10 and data indicating the speed of the vehicle 10. The vehicle information may include information indicating the execution status of each device in the vehicle 10. Then, the in-vehicle device 100 transmits some or all of the data of the vehicle information to the server 200 via the network N1. Further, the in-vehicle device 100 stores the data of some or all of the vehicle information in the database without deleting all of the vehicle information even after the data is transmitted to the server 200.

The in-vehicle device 100 includes a processor 110, a main storage unit 120, a secondary storage unit 130, and a communication interface (including a computer having a communication I/F) 140. The processor 110 is, for example, Central Processing Unit (CPU) or Digital Signal Processor (DSP). The main storage unit 120 is, for example, a Random Access Memory (RAM). The secondary storage unit 130 is, for example, a Read Only Memory (ROM). The secondary storage unit 130 is, for example, a Hard Disk Drive (HDD), a CD-ROM, DVD disc, or a disc recording medium such as a Blu-ray disc. Further, the secondary storage unit 130 may be a removable medium (portable storage medium). Examples of the removable medium include a USB memory or an SD card. The communication I/F 140 is, for example, a Local Area Network (LAN) interface board or wireless communication circuitry for wireless communication.

In the in-vehicle device 100, an operating system (OS), various programs, various information tables, and the like are stored in the secondary storage unit 130. Further, in the in-vehicle device 100, the processor 110 loads the program stored in the secondary storage unit 130 into the main storage unit 120 and executes the program, thereby realizing various functions as described later. However, some or all of the functions of the in-vehicle device 100 may be realized by hardware circuitry such as ASIC or FPGA. Note that the in-vehicle device 100 does not necessarily have to be realized by a single physical configuration, and may be constituted by a plurality of computers that cooperate with each other.

### Server

The server 200 is a server that collects data of some or all of the vehicle information of the vehicle 10. The server 200 receives, from the in-vehicle device 100, some or all of the vehicle information via the network N1. X300 stores the received data in a database. The server 200 performs various kinds of information processing using the received data.

Here, in some cases, the server 200 uses data of some or all of the vehicle information of the vehicle 10 (hereinafter, may be referred to as “necessary data”) in order to perform information processing. In this case, the database in the server 200 may not hold the necessary data. In such cases, the server 200 transmits the request information to the in-vehicle device 100 via the network N1. Here, the request information is information indicating that the server 200 is requesting transmission of necessary data. Accordingly, the server 200 can receive the necessary data from the in-vehicle device 100. Details of a method for the server 200 to receive necessary data from the in-vehicle device 100 will be described later.

A situation in which the server 200 does not hold the necessary data in the database may occur, for example, due to corruption of the necessary data held in the database. In addition, a situation in which the server 200 does not hold the necessary data in the database also occurs, for example, due to the fact that the necessary data has been automatically deleted due to the end of the holding period of the necessary data.

For example, there is a case where the user of the vehicle 10 does not consent to the use of some or all of the data of the vehicle information by the server 200. In this case, the in-vehicle device 100 does not transmit data whose use by the server 200 is not consented by the user of the vehicle 10. Therefore, when the user of the vehicle 10 does not consent to the use of the necessary data by the server 200, the database in the server 200 does not hold the necessary data.

The server 200 includes a computer as well as the in-vehicle device 100. The processor 210, the main storage unit 220, the secondary storage unit 230, and the communication I/F 240 are the same as those of the processor 110, the main storage unit 120, the secondary storage unit 130, and the communication I/F 140, and therefore will not be described.

### Functional Configuration

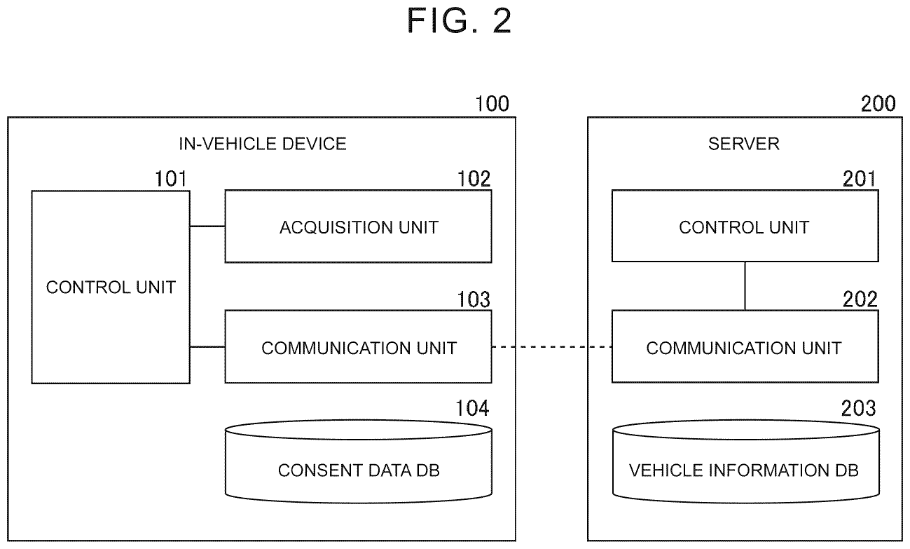

Next, a functional configuration of each of the in-vehicle device 100 and the server 200 constituting the information providing system 1 will be described with reference to FIG. 2. FIG. 2 is a block diagram schematically illustrating an example of the in-vehicle device 100 and the server 200.

### In-Vehicle Device

The in-vehicle device 100 includes a control unit 101, an acquisition unit 102, a communication unit 103, and a vehicle information database 104 (vehicle information DB 104). The control unit 101 has a function to perform arithmetic processing for controlling the in-vehicle device 100. The control unit 101 can be realized by the processor 110 in the in-vehicle device 100. The acquisition unit 102 has a function to acquire vehicle information from an electronic control unit (ECU) or the like of the vehicle 10. The acquisition unit 102 can be implemented by an in-vehicle network interface board or the like in the in-vehicle device 100. The communication unit 103 has a function of connecting the in-vehicle device 100 to a networked N1. The communication unit 103 can be realized by a communication I/F 140 in the in-vehicle device 100.

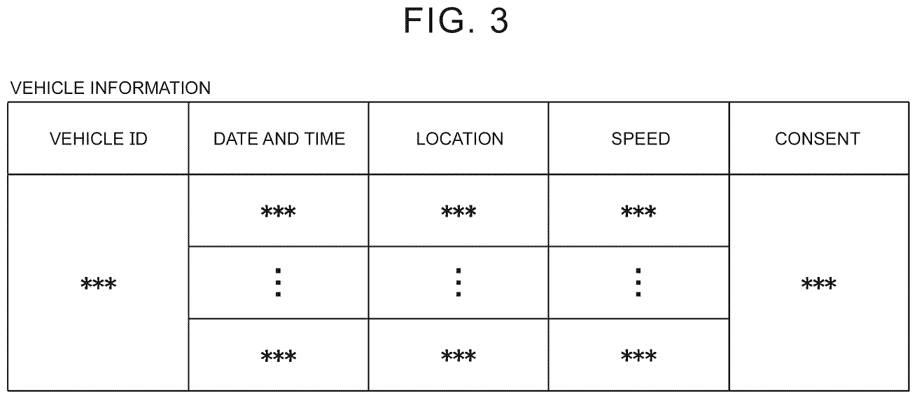

The vehicle information DB 104 has a function of holding vehicle information. FIG. 3 is a diagram illustrating an exemplary table configuration of vehicle information held in the vehicle information DB 104. As illustrated in FIG. 3, the vehicle information includes a vehicle ID field, a date and time field, a location field, a speed field, and a consent field.

In the vehicle ID field, an identifier (vehicle ID) for identifying the vehicle 10 is stored. The date and time field stores information indicating the date and time the control unit 101 acquired the vehicle information of the vehicle 10. The location field stores data (location data) indicating the location of the vehicle 10 on the date and time the control unit 101 acquired the vehicle information of the vehicle 10. The speed field stores data (speed data) indicating the speed of the vehicle 10 on the date and time the control unit 101 acquired the vehicle information of the vehicle 10 is stored. The control unit 101 transmits the vehicle information acquired on each date and time to the server 200, and stores the vehicle information acquired on each date and time in the vehicle information DB 104.

The consent field stores information indicating data that is included in the vehicle information and whose use by the server 200 is consented by the user of the vehicle 10 (hereinafter, sometimes referred to as “consent data”). In the present embodiment, the consent field stores information indicating data whose use by the server 200 is consented by the user of the vehicle 10 out of the location data and the speed data. The user of the vehicle 10 sets in advance which data out of the location data and the speed data is the consent data.

The control unit 101 transmits the consent data out of the vehicle information to the server 200 by the communication unit 103. On the other hand, the control unit 101 does not transmit the data that is not the consent data out of the vehicle information to the server 200. In addition, the control unit 101 stores the vehicle information in the vehicle information DB 104 when transmitting the consent data. At this time, the control unit 101 also stores data other than the consent data in the vehicle information DB 104 as the vehicle information.

In addition, the control unit 101 receives, by the communication unit 103, request information for requesting transmission of necessary data from the server 200. Upon receiving the request information, the control unit 101 acquires necessary data from the vehicle information held in the vehicle information DB 104, and transmits the necessary data to the server 200.

At this time, the necessary data requested to be transmitted in the request information may not be the consent data. In this case, the request information includes information indicating that the server 200 is requesting the user of the vehicle 10 to give a response as to whether to consent to the use of the data by the server 200. In this case, the control unit 101 displays a screen requesting the user of the vehicle 10 to give a response as to whether to consent to the use of the necessary data that is not the consent data by the server 200 (hereinafter also referred to as an “response screen”). The control unit 101 transmits the necessary data to the server 200 when the user of the vehicle 10 enters on the response screen a response to the in-vehicle device 100 that the user consents to the use of the necessary data by the server 200. The control unit 101 does not transmit the necessary data to the server 200 when the user of the vehicle 10 enters on the response screen a response to the in-vehicle device 100 that the user does not consent to the use of the necessary data by the server 200.

### Server

The server 200 includes a control unit 201, a communication unit 202, and a consent data database 203 (consent data DB 203). The control unit 201 has a function to perform arithmetic processing for controlling the server 200. The control unit 201 can be realized by the processor 210 in the server 200. The communication unit 202 has a function of connecting the server 200 to a networked N1. The communication unit 202 can be realized by a communication I/F 240 in the server 200.

The consent data DB 203 has a function of holding consent data received from the in-vehicle device 100. The control unit 201 receives the consent data from the in-vehicle device 100 by the communication unit 202. The control unit 201 stores the received consent data in the consent data DB 203. At this time, the consent data includes information indicating the vehicle ID stored in the vehicle ID field included in the vehicle information and the date and time stored in the date and time field. Further, the consent data includes data designated as consent data out of the location data and speed data included in the vehicle information. The consent data includes information indicating data whose use by the server 200 is consented by the user of the vehicle 10 out of the location data and speed data. The consent data DB 203 may also hold consent data for a plurality of vehicles 10.

The control unit 201 receives a command for instructing execution of information processing (hereinafter, sometimes referred to as “specific process”) using necessary data from an administrator of the server 200 or the like. At this time, the necessary data may not be held in the consent data DB 203. In this case, the control unit 201 sends the request information to the in-vehicle device 100 by the communication unit 202. At this time, the control unit 201 refers to the information (consent information) stored in the consent field included in the vehicle information received from the in-vehicle device 100, and identifies the reason why the vehicle information of the vehicle 10 is not held in the consent data DB 203.

Specifically, the control unit 201 determines whether the necessary data not held in the consent data DB 203 is consent data. When the determination result is affirmative, the control unit 201 identifies that the necessary data has been corrupted or deleted. In this case, the control unit 201 has previously received the necessary data from the in-vehicle device 100. Therefore, the control unit 201 sends to the in-vehicle device 100 request information requesting retransmission of necessary data. Note that the control unit 201 may identify that the necessary data has been deleted by referring to the data deletion history.

When the determination result is negative, the control unit 201 identifies that the user of the vehicle 10 does not consent to the use of the necessary data by the server 200. In this case, the control unit 201 requests the in-vehicle device 100 to transmit the necessary data, and also transmits, to the in-vehicle device 100, request information requesting the user of the vehicle 10 to give a response as to whether to consent to the use of the necessary data by the server 200. In this way, the server 200 can execute the specific process using the necessary data.

### First Process

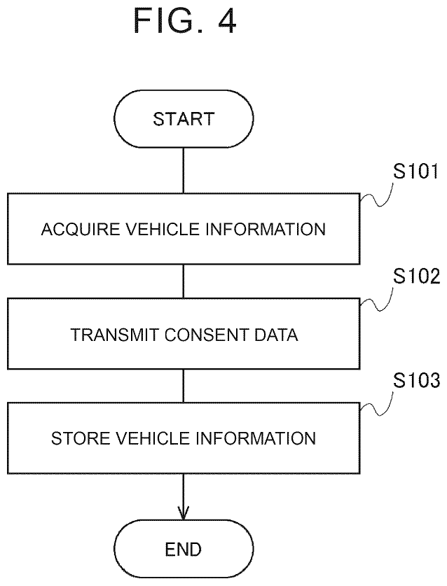

Next, a first process that is executed by the control unit 101 of the in-vehicle device 100 in the information providing system 1 will be described with reference to FIG. 4. FIG. 4 is a flowchart of a first process that is executed by the control unit 101 of the in-vehicle device 100. The first process is repeatedly executed at predetermined intervals. The first process is a process for the in-vehicle device 100 to transmit consent data to the server 200.

In the first process, first, in S101, vehicle information is acquired from the vehicle 10 by the acquisition unit 102. Next, in S102, the consent data of the vehicle information is transmitted to the server 200. In S103, the vehicle information is stored in the vehicle information DB 104. As a result, the in-vehicle device 100 can acquire the vehicle information again. Then, the first process is terminated once.

### Second Process

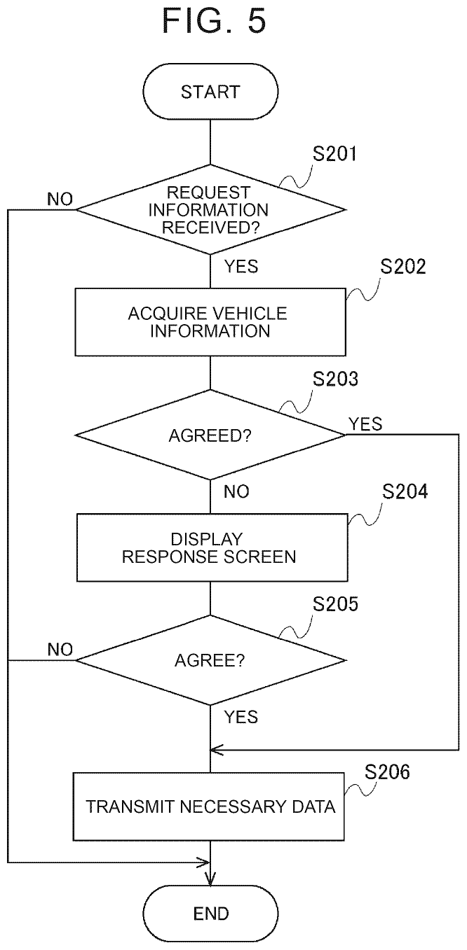

A second process that is executed by the control unit 101 of the in-vehicle device 100 in the information providing system 1 will be described with reference to FIG. 5. FIG. 5 is a flowchart of a second process that is executed by the control unit 101 of the in-vehicle device 100. The second process is repeatedly executed at predetermined intervals. The second process is a process for transmitting necessary data when the in-vehicle device 100 receives the request information.

In the second process, first, in S201, it is determined whether the request information has been received from the server 200. When NO in S201, the data need not be transmitted to the server 200. Therefore, the second process is temporarily ended.

When YES in S201, the vehicle information is acquired from the vehicle information DB 104. Next, in S203, it is determined whether the necessary data requested to be transmitted in the request information is consent data. When YES in S203, the user of the vehicle 10 has already consented to the use of the necessary data requested to be transmitted in the request information by the server 200. Therefore, the necessary data is transmitted to the server 200 in S206. Then, the second process is temporarily ended.

When NO in S203, the response screen is displayed in S204. Next, in S205, it is determined whether the user of the vehicle 10 has entered on the response screen the consent to the use of the necessary data by the server 200. When NO in S205, the user of the vehicle 10 has declined the use of the necessary data by the server 200. Therefore, the second process is once ended.

When YES in S205, the user of the vehicle 10 has consented to the use of the necessary data by the server 200. Therefore, in S206, the necessary data is transmitted to the server 200. Then, the second process is temporarily ended.

### Third Process

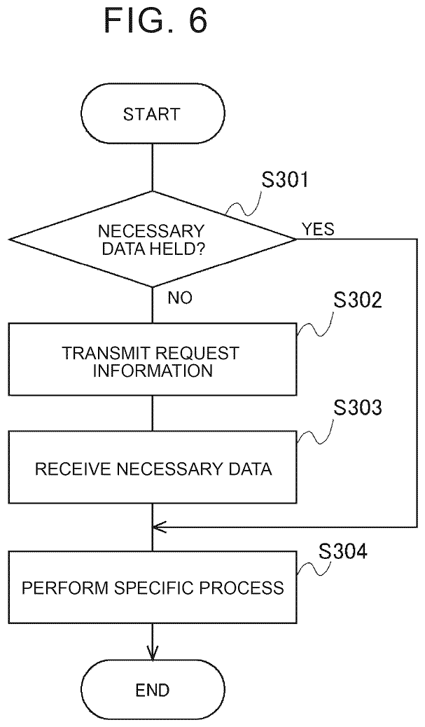

A third process that is executed by the control unit 201 of the server 200 in the information providing system 1 will be described with reference to FIG. 6. FIG. 6 is a flowchart of the third process that is executed by the control unit 201 of the server 200. The third process is repeatedly executed at predetermined intervals. The third process is a process for the server 200 to execute the specific process using the necessary data of the vehicle 10. The third process is started when the server 200 receives a command instructing execution of the specific process from the administrator of the server 200 or the like using the necessary data of the vehicle 10.

In the third process, first, in S301, it is determined whether the necessary data is held in the consent data DB 203. Specifically, when executing the specific process, the server 200 accesses the consent data DB 203 and determines whether the necessary data has been corrupted or deleted. When YES in S301, the server 200 holds the necessary data. Therefore, in S304, the necessary data held in the consent data DB 203 is referred to, and the specific process is executed. Then, the third process is ended.

When NO in S301, the necessary data is not held in the consent data DB 203. Therefore, in S302, request information requesting transmission (retransmission) of the necessary data is sent to the in-vehicle device 100. That is, when, as a result of accessing the consent data DB 203 in S301, the necessary data is found corrupted or deleted in the consent data DB 203, the request information is sent to the in-vehicle device 100. Next, in S303, the necessary data is received (received again) from the in-vehicle device 100. Next, in S304, the specific process is executed using the necessary data. Then, the third process is ended.

As described above, in the information providing system 1, the in-vehicle device 100 transmits the consent data of the vehicle information to the server 200. In addition, the in-vehicle device 100 stores the vehicle information in the vehicle information DB 104. When retransmission of the necessary data is requested because the server 200 has corrupted or deleted the necessary data, the in-vehicle device 100 transmits the necessary data held in the vehicle information DB 104 to the server 200. As a result, in the information providing system 1, the server 200 can re-receive the necessary data, and can execute the specific process. Even when the user of the vehicle 10 previously did not consent to the use of the necessary data by the server 200, the server 200 can receive the necessary data when the user consents to the use of the necessary data by the server 200. In this way, in the information providing system 1, the server 200 can acquire information at a necessary timing, and can execute the specific process.

### Modified Examples

In the present embodiment, the server 200 has consent data DB 203 for storing consent data received from the in-vehicle device 100. However, the server 200 does not necessarily have to have the consent data DB 203. That is, the server 200 may not always hold the consent data. In this case, the server 200 execute the specific process using the consent data (necessary data) received from the in-vehicle device 100, and discards the received consent data after the specifying process is completed. That is, the server 200 executes the specific process in real time using the consent data received from the in-vehicle device 100, and discards the consent data after the specific process is completed. Further, in this case, the server 200 may execute the specific process again after discarding the consent data (after executing the specific process in real time). In this case, the server 200 requests the in-vehicle device 100 to retransmit the necessary data when executing the specific process again after discarding the consent data. That is, the control unit 201 executes S302 to S304 without executing S301 in the third process illustrated in FIG. 6. Even in this manner, in the information providing system 1, the server 200 can acquire information at a necessary timing, and can execute the specific process. In addition, the server 200 does not need to be configured to include the consent data DB 203, so that the cost of the server 200 can be reduced.

### Other Embodiments

The above-described embodiments are mere examples, and the present disclosure can be implemented with appropriate modifications within a range not departing from the scope thereof. Moreover, the processes and units described in the present disclosure can be freely combined and implemented unless technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. Examples of the non-transitory computer-readable storage medium include a random disk such as a magnetic disk (a floppy (registered trademark) disk, a hard disk drive (HDD), and the like), or an optical disc (such as a CD-ROM, a DVD disc, and a Blu-ray disc), a read only memory (ROM), a random access memory (RAM), an EPROM, an EEPROM, a magnetic card, a flash memory, an optical card, and a random type of medium suitable for storing electronic instructions.

What is claimed is:

1. A system comprising a first device and a second device, wherein the first device is configured to
transmit data to the second device and store the data in a first database, and
when retransmission of the data is requested from the second device, transmit the data stored in the first database to the second device.

2. The system according to claim 1, wherein:
the second device includes a second database; and
the second device is configured to
when the data is received from the first device, store the data in the second database,
access the second database when executing a process using the data, and
when, as a result of the access, the data in the second database is found corrupted or deleted, request the first device to retransmit the data.

3. The system according to claim 1, wherein the second device is configured to
execute a process using the data received from the first device,
discard the received data after the process is completed, and
request the first device to retransmit the data when executing the process again after discarding the data.

4. The system according to claim 1, wherein:
the first device is configured to
when a user of the first device does not consent to use of the data by the second device, store the data in the first database without transmitting the data; and
the second device is configured to
when executing a process using the data, request transmission of the data together with a request for a response as to whether to consent to the use of the data by the second device.
